(19) United States
(12) Patent Application Publication
(10) Pub. No.: US 2013/0288142 A1
(43) Pub. Date: Oct. 31, 2013

(54) ELECTRODIALYSIS SYSTEMS AND METHODS FOR ENERGY GENERATION AND WASTE TREATMENT

(71) Applicants: Rongqiang Fu, Singapore (SG); Kee Hoe Ng, Singapore (SG)

(72) Inventors: Rongqiang Fu, Singapore (SG); Kee Hoe Ng, Singapore (SG)

(73) Assignee: SIEMENS PTE. LTD., Singapore, SG (SG)

(21) Appl. No.: 13/883,428

(22) PCT Filed: Oct. 28, 2011
(86) PCT No.: PCT/US11/58227

§ 371 Date: Jun. 13, 2013

Related U.S. Application Data
(60) Provisional application No. 61/409,778, filed on Nov. 3, 2010.

(51) Int. Cl. H01M 8/22

(52) U.S. Cl. CPC H01M 8/227
USPC 429/415; 429/479

(57) ABSTRACT

Reverse electrodialysis (RED) may be used to neutralize acid and caustic effluent waste streams, such as in the semiconductor industry. Power may be generated while waste streams are treated by converting chemical energy into electric energy. A bipolar membrane may be integrated into the RED system. Alternatively, an anion exchange membrane and a cation exchange membrane may be overlapped and used in place of a bipolar membrane. A cell pair with four membranes and four chambers, without a bipolar membrane, may also be implemented.

### FIELD OF THE TECHNOLOGY

One or more aspects relate generally to waste treatment. More particularly, one or more aspects relate to systems and methods for generating energy while treating waste.

### BACKGROUND

Large quantities of acidic and alkaline materials are used in various industries. For example, wafer cleaning is the most frequently repeated step in integrated circuit manufacturing and is one of the most important segments in the semiconductor equipment business. The processes are getting more complicated as device sizes shrink and new materials are used. Some representative acids and bases which are commonly used in such cleaning processes include hydrochloric acid, sulfuric acid, hydrofluoric acid and ammonium hydroxide. A representative semiconductor fabrication plant may consume or at least purchase about 70 to 80 tons of 50% sodium hydroxide solution monthly to neutralize acid wastes. In chemical etching, acids or bases are used to dissolve unwanted materials such as metals, semiconductor materials or glass. The common acids and bases used as etchants include hydrochloric acid, nitric acid, hydrofluoric acid, sodium hydroxide and potassium hydroxide. Mining waste is also an issue.

Acidic and caustic waste effluents are typically treated via a neutralization process prior to disposal. Precipitation and filter press may also be used in treatment. The neutralization process must be carefully controlled due to the exothermic reaction of acids and bases. Several attempts have been proposed to recover or recycle acids and bases such as by diffusion dialysis, ion exchange, low pressure distillation and solvent extraction, but industrial application of such approaches has been very limited to date.

### SUMMARY

In accordance with one or more embodiments, reverse electrodialysis system may comprise an anode, a cathode, a load in electric communication with the anode and the cathode, a first chamber, positioned between the anode and the cathode, bounded by a first ion exchange membrane and a bipolar membrane, the first chamber being in fluid communication with an acidic waste effluent stream, and a second chamber, positioned between the anode and the cathode, bounded by the bipolar membrane and a second ion exchange membrane, the second chamber being in fluid communication with a caustic waste effluent stream.

In some embodiments, the system may further comprise a third chamber, positioned between the anode and the cathode, bounded by the second ion exchange membrane and a third ion exchange membrane, the third chamber being in fluid communication with a salt solution source. The system may further comprise a recycle system configured to recirculate the acidic waste effluent stream to the first chamber. The recycle system may be further configured to recirculate the caustic waste effluent stream to the second chamber. The system may be constructed and arranged to neutralize the acidic and caustic waste effluent streams while converting their chemical energy to electric energy. The system may be constructed and arranged to mix the acidic waste effluent stream at an outlet of the first chamber with the caustic waste effluent stream at an outlet of the second chamber to form a salt solution source. In some embodiments, the system may further comprise a third chamber in fluid communication with the salt solution source. The acidic waste effluent may comprise hydrochloric acid in some embodiments.

In accordance with one or more embodiments, a method of treating effluent waste may comprise providing a reverse electrodialysis system, fluidly connecting a source of acidic waste effluent to a first chamber of the reverse electrodialysis system, fluidly connecting a source of caustic waste effluent to a second chamber of the reverse electrodialysis system, collecting a neutralized effluent stream at an outlet of the reverse electrodialysis system, and providing a load between an anode and a cathode of the reverse electrodialysis system to harness electric energy.

In some embodiments, fluidly connecting the sources of acidic and caustic waste effluent may comprise fluidically coupling a semiconductor fabrication operation to the reverse electrodialysis system. The method may further comprise recycling the acidic waste effluent to the first chamber. In some embodiments, the method may further comprise recycling the caustic waste effluent to the second chamber. The method may further comprise delivering the neutralized effluent stream to a third chamber of the reverse electrodialysis system. In some embodiments, the method may further comprise discharging the neutralized effluent stream. In at least some embodiments, the method may further comprise treating the neutralized effluent stream prior to discharge. In some embodiments, the method may further comprise adjusting an electric resistance of the load.

In accordance with one or more embodiments, a reverse electrodialysis system may comprise an anode, a cathode, a load in electric communication with the anode and the cathode, a first chamber, positioned between the anode and the cathode, bounded by a first ion exchange membrane and a simulated bipolar membrane comprising a cation exchange membrane coupled to an ion exchange membrane, the first chamber being in fluid communication with an acidic waste effluent stream, a second chamber, positioned between the anode and the cathode, bounded by the simulated bipolar membrane and a second ion exchange membrane, the second chamber being in fluid communication with a caustic waste effluent stream, and a third chamber, positioned between the anode and the cathode, bounded by the second ion exchange membrane and a third ion exchange membrane, the third chamber being in fluid communication with a salt solution source.

In some embodiments, the salt solution source may comprise a mixture of the acidic waste effluent stream exiting the first chamber and the caustic effluent stream exiting the third chamber.

In accordance with one or more embodiments, a reverse electrodialysis system may comprise an anode, a cathode, a load in electric communication with the anode and the cathode, a first chamber, positioned between the anode and the cathode, bounded by a first ion exchange membrane and a second ion exchange membrane, the first chamber being in fluid communication with an acidic waste effluent stream and a salt solution source, a second chamber, positioned between the anode and the cathode, bounded by the second ion exchange membrane and a third ion exchange membrane, the second chamber being in fluid communication with the salt solution source, a third chamber, positioned between the anode and the cathode, bounded by the third ion exchange membrane and a fourth ion exchange membrane, the third chamber being in fluid communication with the with a caustic waste effluent stream and the salt solution source, and a fourth chamber, positioned between the anode and the cathode, bounded by the fourth ion exchange membrane and a fifth ion exchange membrane, the fourth chamber being in fluid communication with the salt solution source.

In some embodiments, the salt solution source may comprise a mixture of the acidic waste effluent stream exiting the first chamber and the caustic effluent stream exiting the third chamber.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures. The figures are provided for the purposes of illustration and explanation and are not intended as a definition of the limits of the invention. In the figures:

FIG. 1 presents a schematic of a reverse electrodialysis stack in accordance with one or more embodiments;

FIG. 2 presents a schematic of a reverse electrodialysis system including a bipolar membrane in accordance with one or more embodiments;

FIG. 3 presents a schematic of a waste treatment and energy generation system in accordance with one or more embodiments;

FIG. 4 presents data illustrating the relationship between power output and operational current density in accordance with one or more embodiments;

FIG. 5 presents a schematic of a waste neutralization system in accordance with one or more embodiments;

FIGS. 6 and 7 present schematics of reverse electrodialysis systems in accordance with one or more embodiments;

FIG. 8 presents a reverse electrodialysis system referenced in Example 1 in accordance with one or more embodiments; and

FIGS. 9-15 present data referenced in the accompanying Examples.

### DETAILED DESCRIPTION

Energy may be generated from salinity differences. In accordance with one or more embodiments, systems and methods may generate electric energy from acid and caustic waste streams while simultaneously treating them at a controlled rate. In at least some embodiments, a reverse electrodialysis system and method may convert chemical energy into electric energy during neutralization. Chemical energy is converted to thermal energy during neutralization which may be harvested and recovered in accordance with one or more embodiments. In at least some embodiments, the only discharged stream may be salt waste as energy is harvested.

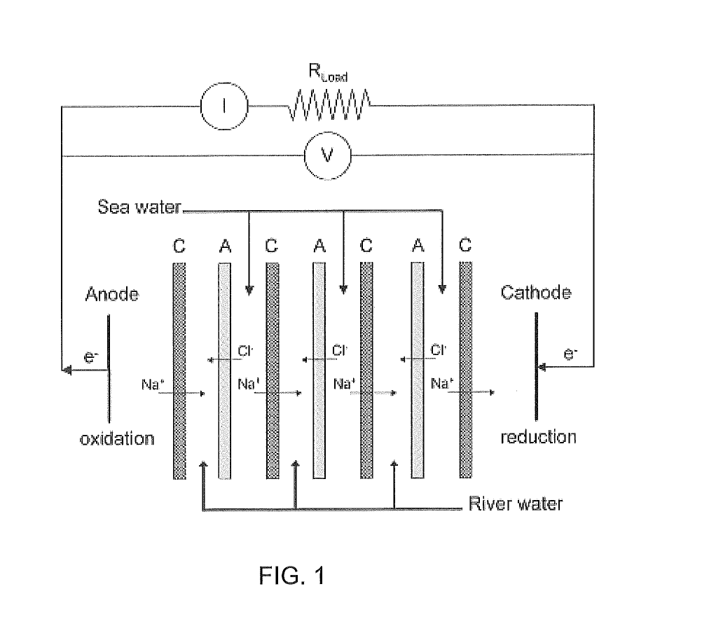

As illustrated in FIG. 1, a reverse electrodialysis (RED) stack is similar to an electrodialysis (ED) stack, with cation exchange membranes (CEM) and anion exchange membranes (AEM) placed alternately between two electrodes. In a RED stack, electric energy can be generated from salinity difference in salt solutions. For example and as illustrated, a power plant may be built near a river delta area to use seawater and river water to generate electric power. In a RED process, the chemical potential difference between solutions of varying salinity may generate a voltage over each membrane and the total potential of the system may generally be the sum of the potential differences over all membranes.

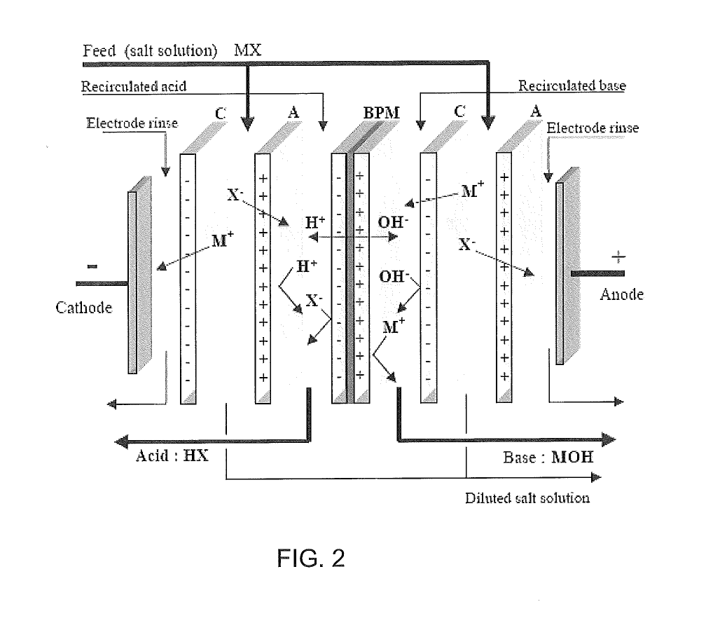

In accordance with one or more embodiments, a RED stack may include at least one bipolar membrane (BPM). A bipolar membrane is generally a combination of a cation exchange layer and an anion exchange layer. Under reverse bias of an electric field, water may be dissociated into protons and hydroxyl ion groups by a BPM. A bipolar membrane electrodialysis stack (BPM-ED) may effectively convert a salt solution (e.g. NaCl) into the corresponding acid (e.g. HCl) and base (e.g. NaOH) as illustrated in FIG. 2. A basic solution may be provided to a first chamber, an acidic solution may be provided to a second chamber, and a salt solution may be provided to a third chamber. A BPM may dissociate water. Under the influence of an electrical potential difference, negatively charged ions may migrate toward the positively charged anode across one or more ion exchange membranes while positively charged ions may migrate toward the negatively charged cathode across one or more ion exchange membranes. The overall result of the electrodialysis process is generally a more acidic solution and a more caustic solution from a salt solution.

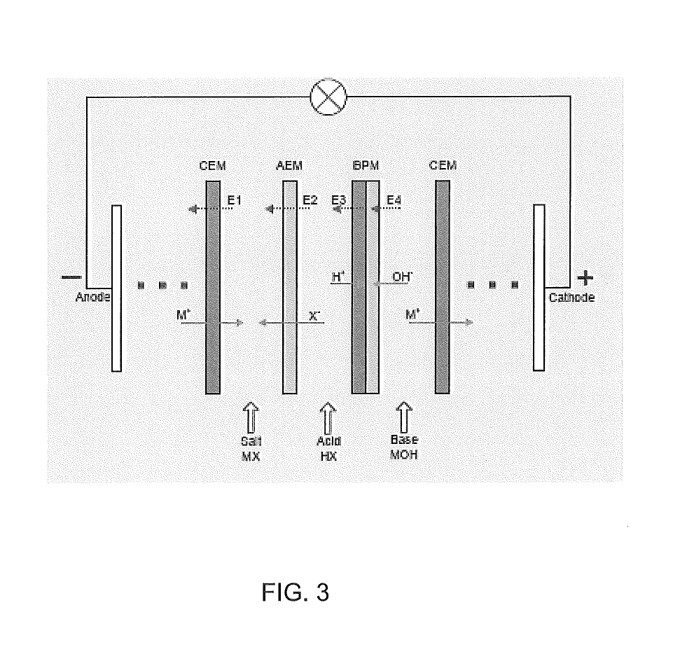

In accordance with one or more embodiments, a BPM-RED may be used to treat acidic waste and caustic waste while generating electric power as illustrated in FIG. 3. Acid and caustic waste streams may be derived from various industrial processes including semiconductor and wafer fabrication, chemical etching, mining and metal processing and acid waste treatment. Some nonlimiting examples of waste streams may include constituents such as hydrochloric acid, sulfuric acid, hydrofluoric acid, and ammonium hydroxide. In a BPM-RED stack, a cell pair may consist of three membranes (CEM, AEM and BPM) and three chambers (salt, acid and base). Cell pairs may be repeated within the stack, for example to achieve a desired number of chambers in the stack. MX, HX and MOH may be used to generically indicate salt, acid and base, respectively. As shown in FIG. 3, protons in acid effluent may diffuse across the cation exchange layer of a BPM into the intermediate layer, whiles hydroxyl in base effluent may diffuse across the anion exchange layer of a BPM into the intermediate layer. Thus, protons and hydroxyl ions may be neutralized in the intermediate layer of the BPM. At the same time, acid group (X⁻) may migrate across an AEM from the acid chamber to the salt chamber, and metal ion (M⁺) may migrate across a CEM from the base chamber into the salt chamber. The acid chamber outlet may therefore become less acidic and the base chamber outlet may become less caustic.

During ion transport, electric potentials may be built up, as indicated by E1, E2, E3 and E4 in FIG. 3. The electric potentials are related to the concentration of the acid, base and salt effluents, and may be estimated with some assumptions. Simply assuming: (1) acid HX concentration of 1.0 mol/l (or pH=0), (2) base MOH concentration of 1.0 mol/l (or pH=14), (3) salt MX concentration 0.5 mol/l and (4) perfect permselectivity of the membranes, the electric potentials may be evaluated as:

$${E}_{1} = \frac{{α}_{CEM} RT}{zF} ln \frac{{a}_{M}}{{a}_{M}^{′}} \approx \frac{8.314 \cdot 298}{96500} ln \frac{1.0}{0.5} = 0.028 volt$$

$${E}_{2} = \frac{{α}_{AEM} RT}{zF} ln \frac{{a}_{X}}{{a}_{X}^{′}} \approx \frac{8.314 \cdot 298}{96500} ln \frac{1.0}{0.5} = 0.018 volt$$

$${E}_{3} = \frac{{α}_{CEL} RT}{zF} ln \frac{{a}_{H}}{{a}_{H}^{′}} \approx \frac{8.314 \cdot 298}{96500} ln \frac{1.0}{{10}^{- 7}} = 0.414 volt$$

$${E}_{4} = \frac{{α}_{AEL} RT}{zF} ln \frac{{a}_{OH}}{{a}_{OH}^{′}} \approx \frac{8.314 \cdot 298}{96500} ln \frac{1.0}{{10}^{- 7}} = 0.414 volt$$

$${E}_{total} = {E}_{1} + {E}_{2} + {E}_{3} + {E}_{4} = 0.018 + 0.018 + 0.414 + 0.414 = 0.864 volt$$

In the above calculations, R is universal gas constant, T is absolute temperature, F is Faraday's constant, a is activity of ions, α is transport number of CEM, AEM, cation exchange layer and anion exchange layer of BPM. The total electric potential in a cell pair is 0.864 volt mainly contributed from BPM (E3+E4).

The power output may be related to the external resistance, or the electric load. The maximum output may be achieved when the external resistance equals the internal resistance of the stack. Assuming area resistance of CEM R_{cem} of 1.0 Ohm·cm², area resistance of AEM Rₐₑₘ of 1.0 Ohm·cm², area resistance of BPM R_{bpm} of 3.0 Ohm·cm², and spacer thickness of 0.038 cm, the internal resistance and maximum power output of a repeating unit, or a cell pair, may be calculated as:

$$\begin{matrix}{R}_{int} = {R}_{cem} + {R}_{aem} + {R}_{bpm} + \frac{{d}_{acid}}{{κ}_{acid}} + \frac{{d}_{base}}{{κ}_{base}} + \frac{{d}_{salt}}{{κ}_{salt}} \\ = 1.0 + 1.0 + 3.0 + \frac{0.038}{0.332} + \frac{0.038}{0.180} + \frac{0.038}{0.046} \\ = 6.2 Ohm \text{-} {cm}^{2}\end{matrix}$$

$$\begin{matrix}{W}_{max} = \frac{{E}_{total}^{2}}{4 {R}_{int}} \\ = \frac{{( 0.864 )}^{2}}{4 \cdot 6.2} \\ = 30 mW \text{/} {cm}^{2} ,\end{matrix}$$

$$or 300 W \text{/} {m}^{2}$$

Thus, the maximum power output could be as high as 300 Watt/m². In most applications, however, the maximum power output is not achieved because the external resistance may not be the same as the internal resistance. The power output may be calculated by:

$$W = {( \frac{{E}_{total}}{{R}_{int} + {R}_{ext}} )}^{2} \cdot {R}_{ext}$$

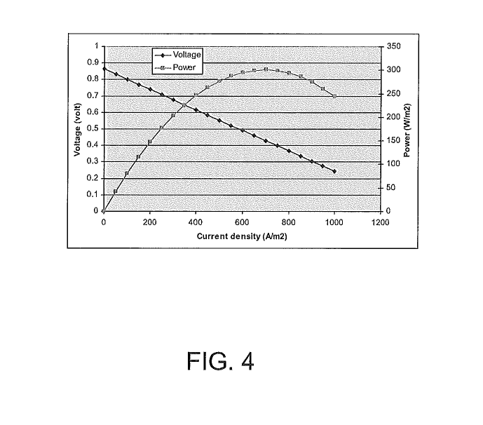

As shown in FIG. 4, the power output relates to the operational current density. In some non-limiting embodiments, for a stack with 500 cell pairs and a cross-sectional area of 0.325 m², the overall open circuit voltage (OCV) may be 432 Volt, and the internal resistance may be calculated as 0.95 Ohm. The maximum power output is calculated as 49112 Watt when the external resistance is the same as the internal resistance. When external resistance increases to 100 ohm, the power output may be 1831 Watt. When external resistance is 1000 ohm, the power output may be 186 Watt. In all these cases, the voltage and power are high enough to be useful.

In accordance with one or more embodiments, the maximum energy possibly drawn from the stack may be calculated from thermodynamic properties of acid and base. The Standard Gibbs free energy of formation for protons, hydroxyl ions and water is 0 kJ/mol, −157.2 kJ/mol and −237.1 kJ/mol, respectively. Mixing 1 mol protons and 1 mol hydroxyl ions could emit 79.9 kJ of energy which is the difference between −237.1 kJ/mol and −157.2 kJ/mol. If the concentration is 1 mol/l for both acid and base, and 1 m³ is used which is 1000 liters, this would equal 79900 kJ in the example volume when the acid and base are mixed. 79900 kJ may be converted to 22.2 kWh/m³. Thus, the thermodynamic energy is 22.2 kWh/m³ for mixing 1 mol/l proton and hydroxyl. The maximum energy produced may be 22.2 kWh.

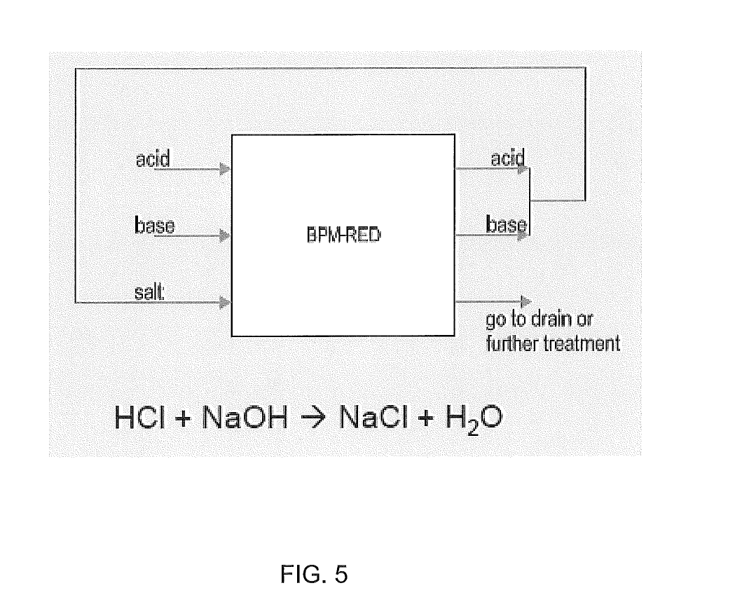

In addition to acid effluent and base effluent, BPM-RED may require an extra salt effluent to accept X⁻ and M⁺ transported from the acid chamber and the base chamber, as shown in FIG. 3. In fact, it could come from the neutralized stream of acid and base, as shown in FIG. 5. Thus, in at least some embodiments, the only discharged stream may be a salt waste when acidic waste and caustic waste are fed into a BPM-RED. It may be necessary that one or more stacks are in series or parallel to achieve the best treatment and energy conversion.

During use, protons and hydroxyl ions move into the intermediate layer of the BPM which may be similar to the BPM-ED operated under forward bias condition. One concern may be the delamination or ballooning of the BPM. The BPM may be made from a casting method or by combining two layers which should be checked prior to use. Some BPMs may be immune to delamination or ballooning, e.g. those originated from a single matrix or base film and functionalized separately from two sides. Since a BPM-RED stack with a few hundred cell pairs may generate a high voltage, the voltage consumption in electrode reactions is not very significant. To get the highest energy output, however, the anolyte could use a base stream and the catholyte could use an acid stream. In this way, no extra electrolyte is needed and minimum electrode voltage consumption may be assumed. In the above energy calculation, low membrane resistance and thin spacer thickness are assumed. In fact, typical ED membranes and spacers, or even CEDI membranes and spacers, may be used. Assuming CEM resistance 3.0 Ohm·cm², AEM resistance 3.0 Ohm·cm², BPM resistance 6.0 Ohm·cm² and all spacer thickness 3.0 mm, the internal resistance of the stack may be calculated as 3.2 Ohm, and power output is 1752 Watt in case of external resistance 100 Ohm. Assuming CEM resistance 8.0 ohm·cm², AEM resistance 8.0 Ohm·cm², BPM resistance 16.0 Ohm·cm² and all spacer thickness 10 mm, the internal resistance can be calculated as 9.4 Ohm and power output is 1558 Watt in the case of external resistance 100 Ohm. These calculations indicate that CEDI modules or acid/caustic modules may be used for BPM-RED.

In accordance with one or more embodiments, the neutralization rate of acid effluent and base effluent may be controlled by the external load. When high electric resistance load is applied, the output current is low and the neutralization rate is slow. When low electric resistance load is applied, the output current becomes high and the neutralization rate becomes fast.

When feeding 1.0 N acid, 1.0 N base and 0.5 N salt, the total electric potential (OCV) in a cell pair is calculated as 0.864 Volt. For a stack with 500 cell pair with external load 1000 ohm, the stack OCV is calculated as 432 Volt, and power output is 186 Watt. The maximum energy, or the thermodynamic energy, is 22.2 kWh/m³ for mixing 1 N acid and base.

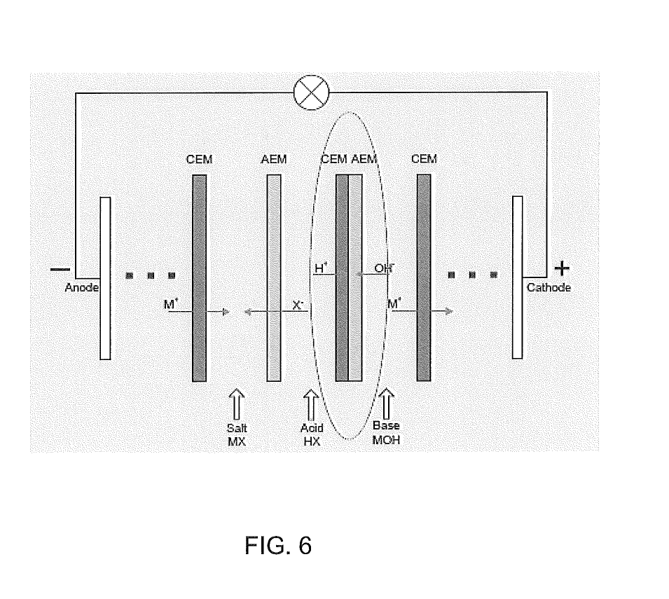

In some embodiments, a pair of membranes may replace a BPM. In at least some embodiments, a CEM and AEM pair may replace a BPM. In accordance with one or more embodiments, a BPM may be simulated by overlapping a CEM and an AEM. In these configurations as illustrated in FIG. 6, a cell pair may include a CEM, an AEM and a contacted CEM/AEM pair. Three streams may be required (acid, base and salt). In such embodiments, three-chamber reverse electrodialysis may be achieved, thus potentially saving one chamber in a cell pair. Simulating a BPM may be associated with lower cost and less concern regarding delamination. A three-chamber reverse electrodialysis system may replace a BPM-RED stack in treating acid and caustic wastes while harvesting energy.

The function and advantages of these and other embodiments will be more fully understood from the following examples. The examples are intended to be illustrative in nature and are not to be considered as limiting the scope of the systems and methods discussed herein.

### Example 1

The electric potential across a membrane was measured with a laboratory test kit. When one side was fed with 1.0 mol/l HCl and the other side with 1.0 mol/l NaOH, the electric potential across an Astom® CMX was measured as only 0.06 mV. However, when BPM was used instead, the electric potential was measured as 0.78 Volt, compared to the above calculated 0.828 Volt.

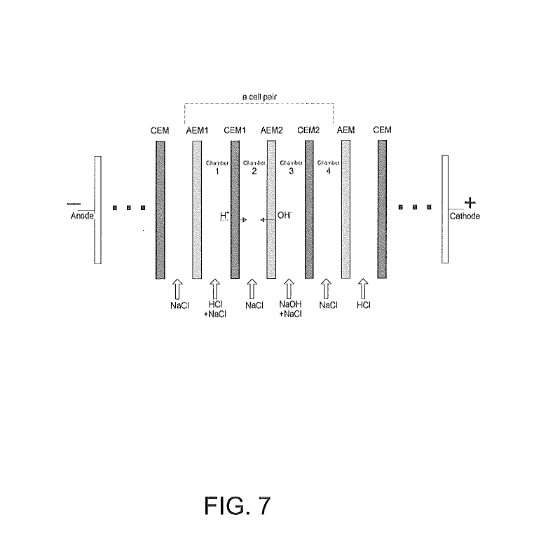

In accordance with one or more embodiments, an alternative ion exchange membrane based electrodialysis system and configuration may be implemented which does not use a BPM. The configuration, illustrated in FIG. 7, involves a cell pair with four membranes and four chambers, compared to a traditional arrangement involving two membranes and two chambers. Compared to the BPM-RED described above and illustrated in FIG. 3, CEM1, chamber 2 and AEM2 replaces the bipolar membrane and achieves a similar function.

The possible energy output may be estimated by calculation assuming these stream concentrations: (1) chamber 1, 1.0 M HCl/0.5 M NaCl, (2) chamber 2, 0.5 M NaCl, (3) chamber 3, 1.0 M NaOH/0.5 M NaCl and (4) chamber 4, 0.5 M NaCl. In chamber 2, the protons and hydroxyl ions may be neutralized. In the diffusion process, it may be assumed that the pH at the CEM side is 5 and the pH at the AEM side is 9. Thus:

$${E}_{AEM 1} = \frac{α RT}{zF} ln ( \frac{a}{{a}^{′}} ) \approx 0.0591 \cdot log ( \frac{1.5}{0.5} ) = 0.028 volt$$

$${E}_{CEM 1} = \frac{α RT}{zF} ln ( \frac{a}{{a}^{′}} ) \approx 0.0591 \cdot log ( \frac{1.0}{{10}^{- 5}} ) = 0.296 volt$$

$${E}_{AEM 2} = \frac{α RT}{zF} ln ( \frac{a}{{a}^{′}} ) \approx 0.0591 \cdot log ( \frac{1.0}{{10}^{- 5}} ) = 0.296 volt$$

$${E}_{CEM 2} = \frac{α RT}{zF} ln ( \frac{a}{{a}^{′}} ) \approx 0.0591 \cdot log ( \frac{1.5}{0.5} ) = 0.028 volt$$

Thus, a voltage of 0.648 Volt in total may be achieved. Further, assuming a stack with 500 cell pairs (N), cross-sectional area of 0.325 m², all membrane resistance 10 Ohm·cm² (typical heterogeneous membrane) and all chamber thickness 0.03 cm, the stack internal resistance may be calculated as:

$$\begin{matrix}{R}_{int} = \frac{N}{A} \\ ( \begin{matrix}{R}_{aem 1} + {R}_{cem 1} + {R}_{aem 2} + {R}_{cem 2} + \\ \frac{{d}_{chamber 1}}{{κ}_{chamber 1}} + \frac{{d}_{chamber 2}}{{κ}_{chamber 2}} + \frac{{d}_{chamber 3}}{{κ}_{chamber 3}} + \frac{{d}_{chamber 4}}{{κ}_{chamber 4}}\end{matrix} ) \\ = \frac{500}{42.5 \cdot 77.6} \\ ( 10 + 10 + 10 + 10 + \frac{0.03}{0.350} + \frac{0.03}{0.046} + \frac{0.03}{0.200} + \frac{0.03}{0.046} ) \\ = 6.3 ohm\end{matrix}$$

$$\begin{matrix}{W}_{max} = \frac{{( N \cdot E )}^{2}}{4 {R}_{int}} \\ = \frac{{( 500 \cdot 0.648 )}^{2}}{4 \cdot 6.30} \\ = 4166 watt\end{matrix}$$

Thus for a stack with 500 cell pairs, the OCV may be 324 Volt, and maximum power output may be 4166 Watt. However in most applications, the external load resistance may be much higher than the internal resistance. When external load is 1000 ohm, the power output may be calculated by:

$$W = {( \frac{N \cdot {E}_{total}}{{R}_{int} + {R}_{ext}} )}^{2} \cdot {R}_{ext} = {( \frac{500 \cdot 0.648}{6.3 + 1000} )}^{2} \cdot 1000 = 104 watt$$

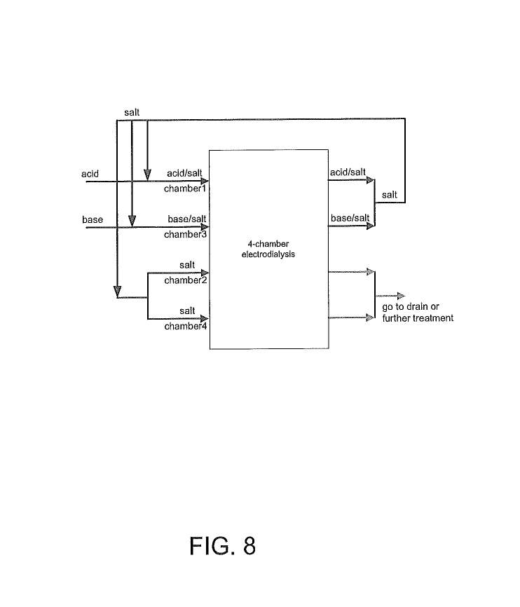

A non-limiting system configuration is presented in FIG. 8. The effluents of chamber 1 (acid/salt) and chamber 3 (base/salt) mix together. The mixed stream is fed back as influents in chamber 2 and chamber 4, and also fed to chamber 1 and chamber 3 to add salt into acid and base. The system net effluents from chamber 2 and chamber 4, nearly neutralized, go to drain or for further treatment. Thus, the net results are neutralized stream and electric energy from acid and base wastes.

Membrane stability when exposed to waste acid and base may be a consideration, especially anion exchange membrane contacting strong base. For cost reasons, heterogeneous ion exchange membranes may be an option, but the chemical stability should be a consideration. Salt addition in acid and base streams may or may not be necessary.

### Example 2

An experiment was conducted with a lab ED module to test the electric potential. The configuration was similar to CEM1, chamber 2 and AEM2 discussed above with reference to FIG. 7. Two platinum foils were placed to measure the voltage across the two membranes. When all three chambers were fed with 0.5 M NaCl solution, the OCV measured by the foils was only 0.03 Volt. When the chambers were fed with 1.0 M HCl, 0.5M NaCl and 1.0 M NaOH, respectively, the OCV was measured as 0.52 Volt.

### Example 3

A lab module with Astom® CMX and AMX was built in accordance with one or more embodiments generally represented by FIG. 6 involving a contacted CEM/AEM pair. The module cross-section area was 113 cm². The module had 20 cell pairs with spacer thickness of 0.4 mm. A resistor box was used as the electric load to verify the module power output.

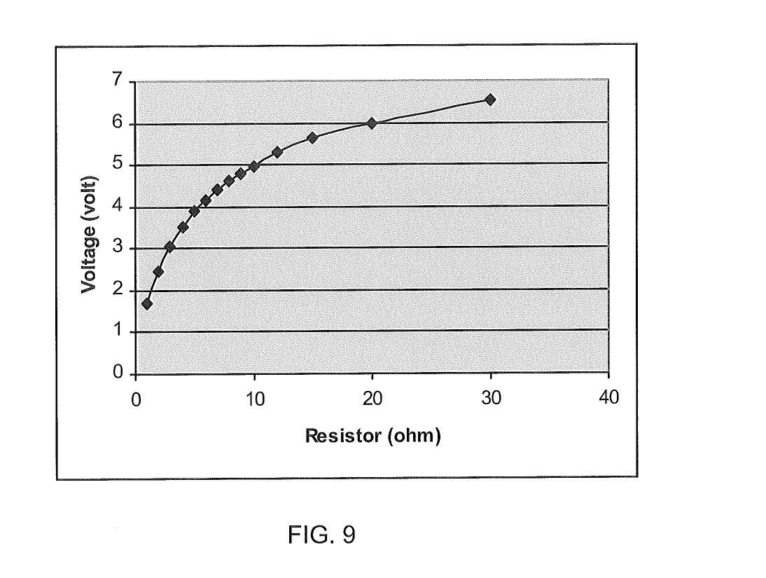

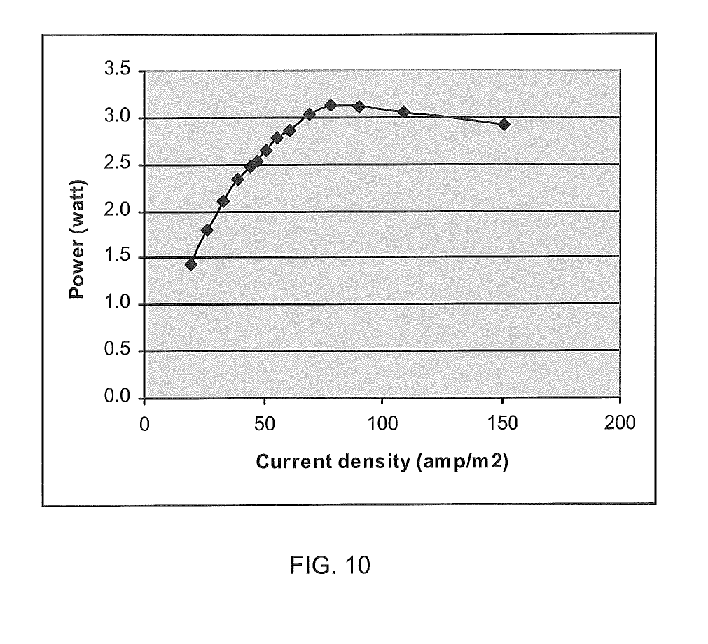

When hydrochloric acid (HCl) 5 wt. %, sodium hydroxide (NaOH) 5 wt. % and sodium chloride (NaCl) 0.5 M were used as acid, base and salt streams respectively, and HCl 5 wt. % as anode and cathode electrolytes, the voltage versus resistance data that was collected is shown in FIG. 9, and power versus current density that was collected is shown in FIG. 10. The test was at ambient temperature. In the test conditions, the maximum power output was about 3.2 Watt. If the mechanical leakage in the module were to be minimized and a redox couple used as anode/cathode electrolyte, a higher power output could be expected.

### Example 4

In a first experimental run, HCl 5 wt % solution was used as acid stream, NaOH 5 wt % was used as base stream, and NaCl 0.05 M was used as salt stream. In a second experimental run, an industrial acid waste solution having a pH of about 0.7 was used as acid stream, NaOH 5 wt % was used as base stream, and NaCl 0.05 M was used as salt stream. HCl 5 wt % was used as anode and cathode electrolytes in both experimental runs. A lab module of 20 cell pairs with cross-sectional area of 58.96 cm² was used for both runs.

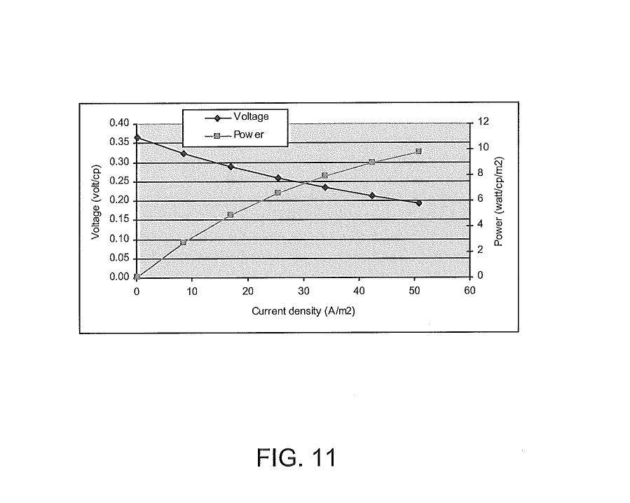

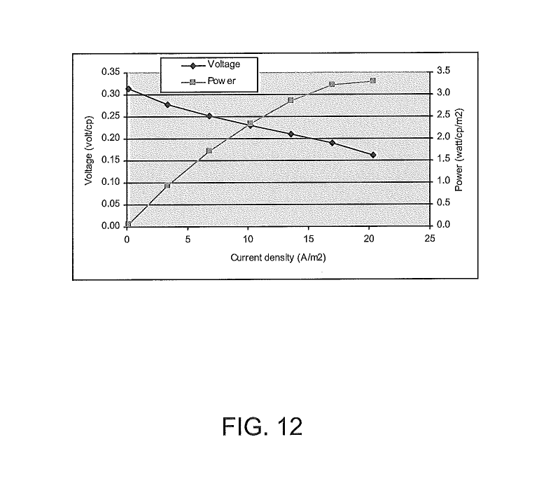

FIG. 11 presents voltage and power data for the first experimental run. FIG. 12 presents voltage and power data for the second experimental run. Maximum power output data is presented in the table below:

| | Pₘₐₓ | 500 cp size module, |
|---|---|---|
| | (watt/cp/m²) | 0.325 m²/cp (watt) |
| HCl 5 wt % (1.4M H) | 9.77 | 1588 |
| Waste acid (0.2M H) | 3.30 | 536 |

### Example 5

In a first experimental run, 1.5 liters of HCl 5 wt % solution was recirculated as acid stream, 1.5 liters of NaOH 5 wt % was recirculated as base stream, and NaCl 0.05 M was used as salt stream in a once-through manner. In a second experimental run, 1.5 liters of an industrial acid waste solution having a pH of about 0.7 was recirculated as acid stream, 1.5 liters of NaOH 5 wt % was recirculated as base stream, and NaCl 0.05 M was used as salt stream in a once-through manner. Recirculated HCl 5 wt % was used as anode and cathode electrolytes in both experimental runs. A 0.1 amp current (16.96 amp/m²) was used in the first experimental run. A 0.1 amp current (16.96 amp/m²) followed by 0.05 amp (8.48 amp/m²) current was used in the second experimental run.

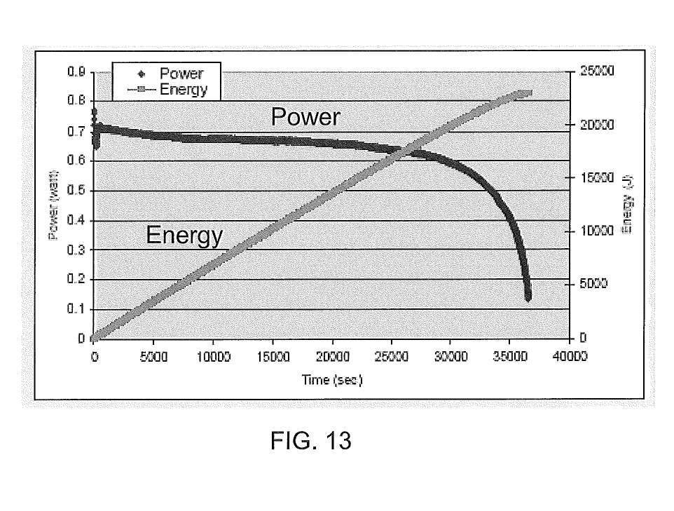

Energy data for the first experimental run is presented in FIG. 13 and summarized below. Energy was generated by the module from the HCl 5 wt % solution with an efficiency of about 15% compared to the theoretical yield.

| Time | [H] in acid | Energy | Energy | Energy |
|---|---|---|---|---|
| (sec) | (mol/l) | (J, accum) | (J/mol of H) | (wh/mol) |
| 1686 | 1.37 | 1331 | 10147 | 2.82 |
| 7292 | 1.13 | 5058 | 5117 | 1.42 |
| 11248 | 0.78 | 7727 | 9615 | 2.67 |
| 15991 | 0.56 | 10905 | 11799 | 3.28 |
| 20304 | 0.40 | 13766 | 14868 | 4.13 |
| 26912 | 0.21 | 18026 | 17407 | 4.84 |
| 34052 | 0.05 | 22118 | | |
| | | | Average | 3.19 |

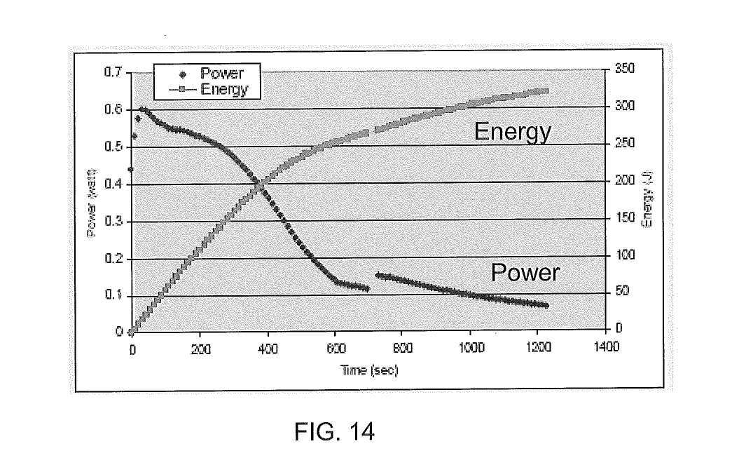

Energy data for the second experimental run is presented in FIG. 14 and summarized below. Energy was generated by the module from the waste acid with an efficiency of about 5% compared to the theoretical yield.

| Time | [H] in acid | Energy | Energy | Energy |
|---|---|---|---|---|
| (sec) | (mol/l) | (J, accum) | (J/mol of H) | (wh/mol) |
| 0 | 0.19 | 0 | 5102 | 1.42 |
| 663 | 0.15 | 262 | 2641 | 0.73 |
| 1201 | 0.14 | 321 | | |
| | | | Average | 1.08 |

The energy yield could be improved by addressing potential mechanical leaks, proton diffusion and operational issues associated with the modules.

### Example 6

About 200 to about 400 tons of sulfuric acid waste may be produced when manufacturing 1 ton of titanium white. Assuming 0.2 M acidity of the sulfuric acid and 5% module efficiency, 64.8 kWh/ton Ti of energy may be generated. Assuming 0.2 M acidity of the sulfuric acid and 50% module efficiency, 672 kWh/ton Ti of energy may be generated.

### Example 7

A copper and gold mining and processing plant may be associated with a treatment capacity of 12,000 m³ of acid waste per day. Assuming 0.2 M acidity and 5% module efficiency, 25,920 kWh/day of energy may be generated. Assuming 0.2 M acidity and 50% module efficiency, 268,800 kWh/day of energy may be generated.

### Example 8

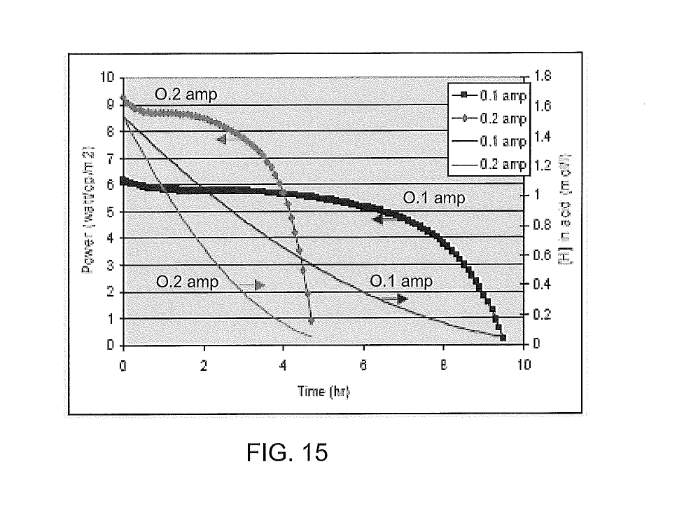

The following data, as presented in FIG. 15, was collected from a mini-lab module, 20 cp. 1.5 liters of HCl 5 wt % was recirculated as the acid stream.

| Membrane | [H] inlet | [H] outlet | Current | Time | Power | Capacity | Power | Power |
|---|---|---|---|---|---|---|---|---|
| m²(cp) | mol/l | mol/l | A/m² | hr | w/m²(cp) | liter/hr/m²(cp) | w/m²(cp) | w/liter |
| 0.1179 | 1.54 | 0.2 | 16.96 | 7.30 | 5.53 | 1.74 | 5.53 | 3.17 |
| 0.1179 | 1.54 | 0.4 | 16.96 | 5.60 | 5.71 | 2.27 | 5.71 | 2.51 |
| 0.1179 | 1.54 | 0.6 | 16.96 | 4.30 | 5.79 | 2.96 | 5.79 | 1.96 |
| 0.1179 | 1.54 | 0.2 | 33.92 | 3.65 | 8.27 | 3.49 | 8.27 | 2.37 |
| 0.1179 | 1.54 | 0.4 | 33.92 | 2.80 | 8.56 | 4.54 | 8.56 | 1.88 |
| 0.1179 | 1.54 | 0.6 | 33.92 | 2.15 | 8.68 | 5.92 | 8.68 | 1.47 |

### Example 9

An economic model was constructed based on select cost assumptions. Also assumed was a 500 cell pair module with a cross-sectional area of 0.325 m², configured as in FIG. 6. Total CEM is 325 m² and total AEM is 325 m².

| [H] inlet | [H] outlet | Current | Capacity | Power | Capacity | Power | Energy | Cost | Cost | Payback |
|---|---|---|---|---|---|---|---|---|---|---|
| mol/l | mol/l | amp/m² | liter/hr/m²(cp) | w/m³(cp) | liter/hr | w | MWH | US$/KW | US$/MWH | Year |
| 1.54 | 0.2 | 16.96 | 1.74 | 5.53 | 283 | 899 | 39.4 | 5199 | 119 | 4.0 |
| 1.54 | 0.4 | 16.96 | 2.27 | 5.71 | 369 | 928 | 40.6 | 5035 | 115 | 3.8 |
| 1.54 | 0.6 | 16.96 | 2.96 | 5.79 | 481 | 941 | 41.2 | 4965 | 113 | 3.8 |
| 1.54 | 0.2 | 33.92 | 3.49 | 8.27 | 566 | 1344 | 58.9 | 3476 | 79 | 2.6 |
| 1.54 | 0.4 | 33.92 | 4.54 | 8.56 | 738 | 1391 | 60.9 | 3359 | 77 | 2.6 |
| 1.54 | 0.6 | 33.92 | 5.92 | 8.68 | 961 | 1411 | 61.8 | 3312 | 76 | 2.5 |

Power yield was expected to be even higher when improved power management is achieved.

Having now described some illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

It is to be appreciated that embodiments of the devices, systems and methods discussed herein are not limited in application to the details of construction and the arrangement of components set forth in the following description or illustrated in the accompanying drawings. The devices, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A reverse electrodialysis system, comprising:
an anode;
a cathode;
a load in electric communication with the anode and the cathode;
a first chamber, positioned between the anode and the cathode, bounded by a first ion exchange membrane and a bipolar membrane, the first chamber being in fluid communication with an acidic waste effluent stream; and
a second chamber, positioned between the anode and the cathode, bounded by the bipolar membrane and a second ion exchange membrane, the second chamber being in fluid communication with a caustic waste effluent stream.

2. The system of claim 1, further comprising a third chamber, positioned between the anode and the cathode, bounded by the second ion exchange membrane and a third ion exchange membrane, the third chamber being in fluid communication with a salt solution source.

3. The system of claim 1, further comprising a recycle system configured to recirculate the acidic waste effluent stream to the first chamber.

4. The system of claim 3, wherein the recycle system is further configured to recirculate the caustic waste effluent stream to the second chamber.

5. The system of claim 1, wherein the system is constructed and arranged to neutralize the acidic and caustic waste effluent streams while converting their chemical energy to electric energy.

6. The system of claim 5, wherein the system is constructed and arranged to mix the acidic waste effluent stream at an outlet of the first chamber with the caustic waste effluent stream at an outlet of the second chamber to form a salt solution source.

7. The system of claim 6, wherein the system further comprises a third chamber in fluid communication with the salt solution source.

8. The system of claim 1, wherein the acidic waste effluent comprises hydrochloric acid.

9. A method of treating effluent waste, comprising:
providing a reverse electrodialysis system;
fluidly connecting a source of acidic waste effluent to a first chamber of the reverse electrodialysis system;
fluidly connecting a source of caustic waste effluent to a second chamber of the reverse electrodialysis system;
collecting a neutralized effluent stream at an outlet of the reverse electrodialysis system; and
providing a load between an anode and a cathode of the reverse electrodialysis system to harness electric energy.

10. The method of claim 9, wherein fluidly connecting the sources of acidic and caustic waste effluent comprises fluidically coupling a semiconductor fabrication operation to the reverse electrodialysis system.

11. The method of claim 10, further comprising recycling the acidic waste effluent to the first chamber.

12. The method of claim 9, further comprising recycling the caustic waste effluent to the second chamber.

13. The method of claim 9, further comprising delivering the neutralized effluent stream to a third chamber of the reverse electrodialysis system.

14. The method of claim 9, further comprising discharging the neutralized effluent stream.

15. The method of claim 14, further comprising treating the neutralized effluent stream prior to discharge.

16. The method of claim 9, further comprising adjusting an electric resistance of the load.

17. A reverse electrodialysis system, comprising:
an anode;
a cathode;
a load in electric communication with the anode and the cathode;
a first chamber, positioned between the anode and the cathode, bounded by a first ion exchange membrane and a simulated bipolar membrane comprising a cation exchange membrane coupled to an ion exchange membrane, the first chamber being in fluid communication with an acidic waste effluent stream;
a second chamber, positioned between the anode and the cathode, bounded by the simulated bipolar membrane and a second ion exchange membrane, the second chamber being in fluid communication with a caustic waste effluent stream; and
a third chamber, positioned between the anode and the cathode, bounded by the second ion exchange membrane and a third ion exchange membrane, the third chamber being in fluid communication with a salt solution source.

18. The system of claim 17, wherein the salt solution source comprises a mixture of the acidic waste effluent stream exiting the first chamber and the caustic effluent stream exiting the third chamber.

19. A reverse electrodialysis system, comprising:
an anode;
a cathode;
a load in electric communication with the anode and the cathode;
a first chamber, positioned between the anode and the cathode, bounded by a first ion exchange membrane and a second ion exchange membrane, the first chamber being in fluid communication with an acidic waste effluent stream and a salt solution source;
a second chamber, positioned between the anode and the cathode, bounded by the second ion exchange membrane and a third ion exchange membrane, the second chamber being in fluid communication with the salt solution source;
a third chamber, positioned between the anode and the cathode, bounded by the third ion exchange membrane and a fourth ion exchange membrane, the third chamber being in fluid communication with the with a caustic waste effluent stream and the salt solution source; and
a fourth chamber, positioned between the anode and the cathode, bounded by the fourth ion exchange membrane and a fifth ion exchange membrane, the fourth chamber being in fluid communication with the salt solution source.

20. The system of claim 19, wherein the salt solution source comprises a mixture of the acidic waste effluent stream exiting the first chamber and the caustic effluent stream exiting the third chamber.
